(19) United States
(12) Patent Application Publication
(10) Pub. No.: US 2026/0332527 A1
(43) Pub. Date: Oct. 22, 2026

(54) LANE STAGGERING IN MULTI-LANE COMMUNICATION INTERFACE LINKS

(71) Applicant: NVIDIA Corporation, Santa Clara, CA (US)

(72) Inventors: Hitendra Krishna Dutt, Cupertino, CA (US); Steve Glaser, San Francisco, CA (US); Robert Huang, Fremont, CA (US)

(21) Appl. No.: 19/186,419

(22) Filed: Apr. 22, 2025

(51) Int. Cl. H04L 47/122; G06F 13/42

(52) U.S. Cl. CPC H04L 47/122; G06F 13/4282; G06F 2213/0026

(57) ABSTRACT

A device connected to a link of a multi-lane communication interface causes link traffic to be migrated from multiple lanes of the multi-lane communication interface to a subset of the multiple lanes of the multi-lane communication interface. One or more tasks are performed on another subset of the plurality of lanes. Link traffic is caused to be restored on the multiple lanes.

### TECHNICAL FIELD

Aspects and embodiments of the present disclosure relate to communication interfaces in computing systems, and in particular to lane staggering in multi-lane communication interface links.

### BACKGROUND

A communication interface can enable data transfer between various components in a computing system, such as central processing units (CPUs), graphics processing units (GPUs), data processing units (DPUs), network interface controllers (NICs), data storage devices, etc.

### BRIEF DESCRIPTION OF THE DRAWINGS

Various embodiments in accordance with the present disclosure will be described with reference to the drawings, in which:

FIG. 1A is a block diagram of an example system architecture for a communication system, in accordance with an embodiment;

FIG. 1B is a block diagram of an example system architecture for a communication system, in accordance with an embodiment;

FIG. 1C is a block diagram of an example system architecture for a communication system, in accordance with an embodiment;

FIG. 1D is a block diagram of an example system architecture for a communication system, in accordance with an embodiment;

FIG. 2 is a block diagram of an example device in a communication system, in accordance with an embodiment;

FIG. 3A depicts a sequence of link states in a link bandwidth change operation, in accordance with an embodiment;

FIG. 3B depicts a sequence of link states in a link maintenance operation, in accordance with an embodiment;

FIG. 4 is a flow diagram of an example method for lane staggering in multi-lane communication interface links, in accordance with an embodiment;

FIG. 5 is a block diagram illustrating an exemplary computer system, in accordance with an embodiment;

FIG. 7 is a block diagram of a computing system having a CPU and a GPU in a single integrated circuit, in accordance with an embodiment; and

FIG. 8 is a block diagram of a computing system having tensor core GPUs, in accordance with an embodiment.

### DETAILED DESCRIPTION

Aspects of the present disclosure relate to multi-lane communication interfaces in computing systems. A multi-lane communication interface can enable data transfer between various components in a computing system, such as central processing units (CPUs), graphics processing units (GPUs), data processing units (DPUs), network interface controllers (NICs), data storage devices, etc. A multi-lane communication interface can connect two devices using one or more lanes to form a link, where the lanes in aggregate can achieve higher bandwidth for the link than a single lane. Examples of multi-lane communication interfaces include Peripheral Component Interconnect Express (PCIe), Compute Express Link (CXL), NVLINK, InfiniBand, and Ethernet. Multi-lane communication interfaces can be used in various applications ranging from data centers (e.g., high-performance computing, artificial intelligence, gaming, etc.) to consumer electronics (e.g., desktops, mobile devices) to automotive.

Some multi-lane communication interfaces can support link width resizing, where the number of lanes used in a link can be dynamically reduced or increased as needed based on factors such as bandwidth utilization, power consumption, or similar. Link width resizing can be achieved via negotiation between the linked devices. However, multi-lane communication interfaces can be limited in which lanes can be enabled or disabled, and disabled lanes may not be usable for any purpose while dormant. Furthermore, various link maintenance tasks such as transitioning between power states, changing link bandwidth, equalizing and training links, etc. can be time-and resource-consuming and can prevent traffic flow on the link. As a result, devices using multi-lane communication interfaces can experience traffic interruptions due to slow transitions between link states and occasional link maintenance such as re-equalizing.

Aspects of the present disclosure address these and other challenges by providing a multi-lane communication interface that supports selective enabling and disabling of sets of lanes, as well as swapping sets of enabled and disabled lanes. Furthermore, disabled lanes can be in a semi-active state that supports link maintenance tasks such as bandwidth upgrades and link training. Thus, link traffic can temporarily be migrated to a subset of lanes while maintenance tasks are performed on another subset, and then the subsets can be swapped. When all maintenance tasks are completed, link traffic can be restored to the full set of lanes. As a result, devices can continue to use the link for sending and receiving traffic while maintenance tasks are simultaneously performed. This can minimize traffic interruptions for linked devices and improve power state transition times.

In an embodiment, a device connected to a link of a multi-lane communication interface can negotiate with another device on the link to change the link width to a subset of lanes and migrate traffic to those lanes. The device can then perform maintenance tasks on the disabled lanes in collaboration with the other device while maintaining regular operation on the subset of lanes. When the maintenance tasks are complete, the devices can negotiate restoration of the link width to the full set of lanes.

In an embodiment, before restoring the full link width, the devices can negotiate a swap of the traffic from the enabled lanes to the disabled lanes and perform the same or similar maintenance tasks on the newly disabled lanes. Thus, tasks such as bandwidth upgrades and link training can be performed for the full link while maintaining traffic flow. In an embodiment, the link can be divided into more than two subsets of lanes, with each subset swappable to one of the enabled, maintenance-disabled, or fully-disabled states.

In an embodiment, lane swapping and incremental maintenance tasks can be initiated in a device by software, such as a driver or an application. Thus, link maintenance tasks can be optimally timed for different use cases, such as high-performance computing, artificial intelligence, gaming, and automotive use cases. Thus, computing systems using these multi-lane communication interfaces can continue to support traffic flow on a subset of lanes while link maintenance tasks are ongoing, which can reduce traffic interruptions and link down time.

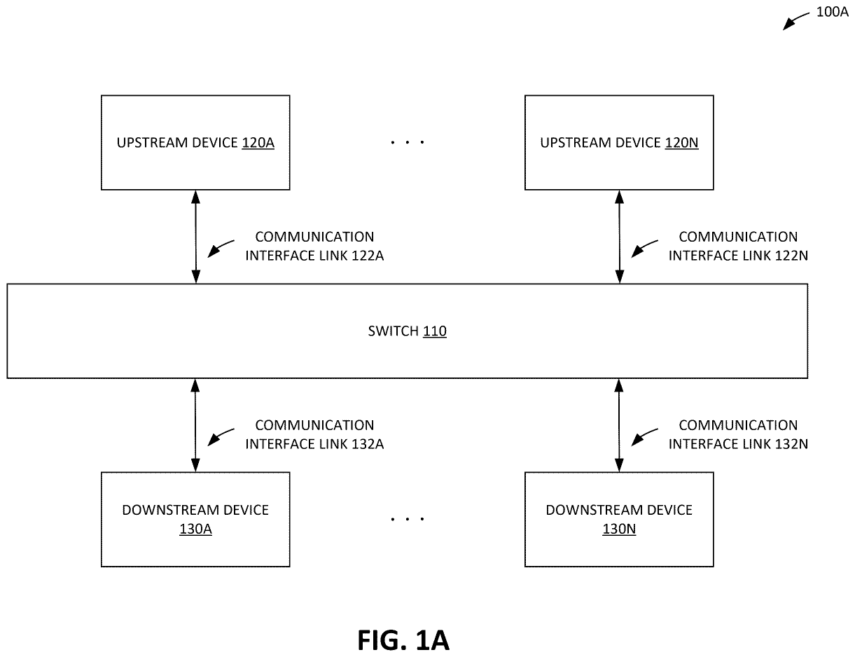

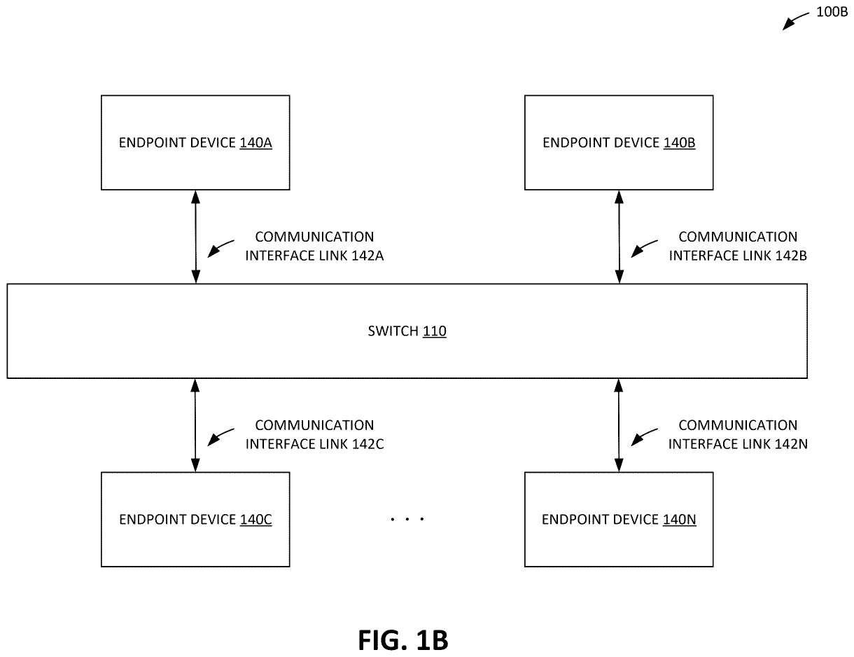

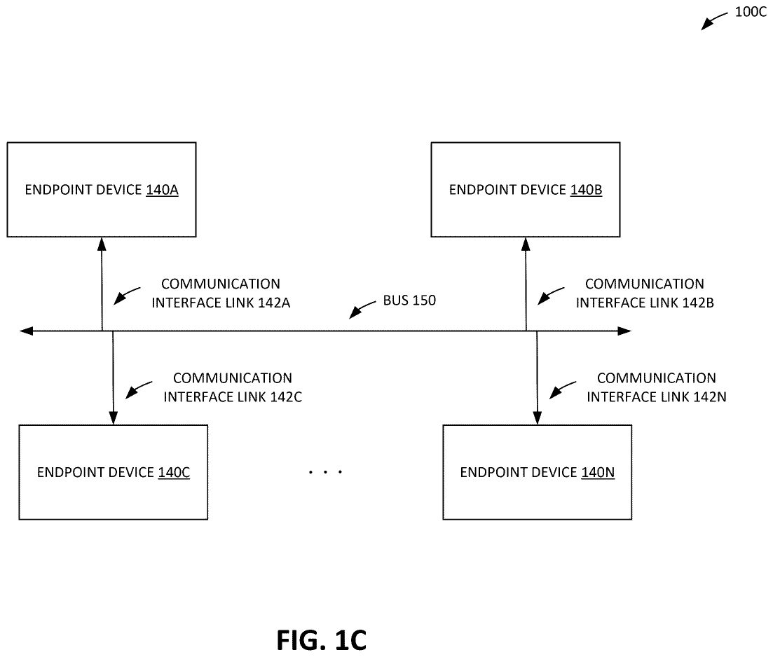

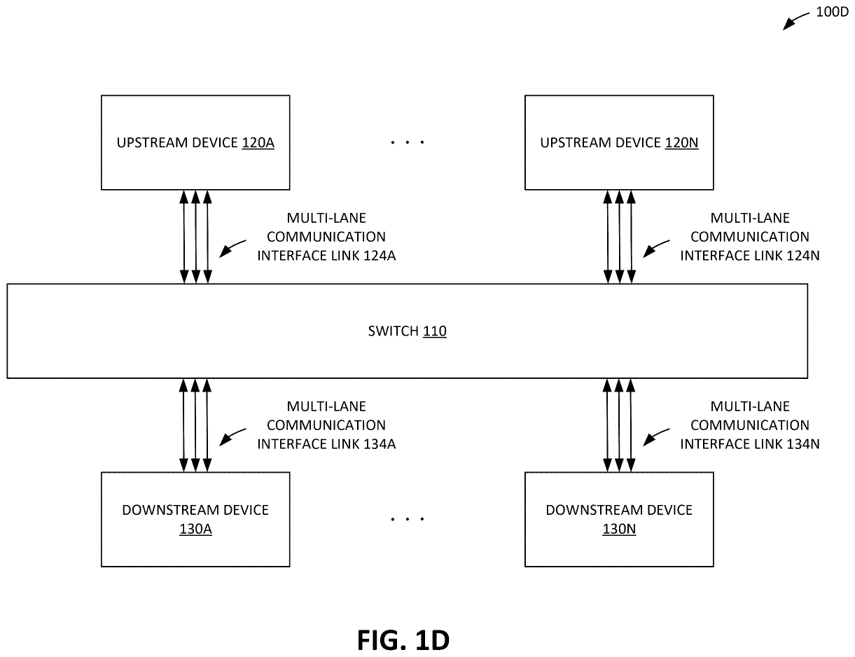

FIG. 1A is a block diagram of an example system architecture 100A for a communication system, in accordance with an embodiment. System architecture 100A (also referred to as “system” herein) includes switch 110, upstream devices 120A-N, and downstream devices 130A-N. System 100A further includes communication interface links 122A-N and 132A-N connecting the above components. In various embodiments, system 100A can include more or fewer components in different configurations than those depicted in FIG. 1A. For example, system 100A can include additional switches operating upstream or downstream from switch 110.

Communication system 100A is associated with a communication interface. The communication interface can define common media and/or protocols that devices and applications running thereon can use to communicate with each other. For example, the communication interface can define one or more layers of the Open Systems Interconnection (OSI) model, such as a physical layer, data link layer, application layer, and so on. Examples of communication interfaces that can be associated with communication system 100A include Peripheral Component Interconnect Express (PCIe), Compute Express Link (CXL), NVLINK, InfiniBand, Ethernet, Universal Serial Bus (USB), Inter-Integrated Circuit (I2C), Serial Peripheral Interface (SPI), and similar.

Devices participating in communication system 100A can be connected together via links compliant with the communication interface. A link can be a unidirectional or bidirectional channel for sending and/or receiving data between two devices and can be associated with underlying physical media and protocols defined by the communication interface. The performance of a link can be characterized in various ways. For example, link bandwidth can refer to how much data can traverse the link in a period of time, and link latency can refer to how much time it takes for data to traverse the link. Link error rate can refer to how often data is lost or corrupted on the link. In various embodiments, some of these performance characteristics can be tunable. For example, a link can be associated with a plurality of bandwidth states that can support more or less bandwidth depending on the needs of the connected devices/applications. In various embodiments, a link may be disabled temporarily to allow transition between bandwidth states or to allow performance of other operations (e.g., link maintenance) on the lin.

In various embodiments, the communication interface can support different types of devices, such as switches and endpoint devices. Switch 110 can be a device that routes data traffic between two or more devices connected to switch 110. In various embodiments, switch 110 can use look-up tables, addresses embedded in data packets, and/or other techniques to determine which device(s) to route traffic to. In various embodiments, a data packet received at switch 110 can be routable to any of the connected devices or to a subset of connected devices. For example, switch 110 can be a physical device that implements two or more virtual switches, which can each be associated with a respective tree of routable devices connected to switch 110.

Upstream devices 120A-N are endpoint devices that can perform a host or controller role in various embodiments. Upstream devices 120A-N can be connected to one or more downstream devices 130A-N via switch 110. Downstream devices 130A-N can perform a hosted or controlled role in various embodiments. Examples of upstream devices include PCIe root complexes or root ports thereof, and USB host-class devices. Examples of downstream devices include PCIe endpoint devices and USB device-class devices. In an embodiment, a communication system can have a single upstream device and one or more downstream devices.

FIG. 1B is a block diagram of an example system architecture 100B for a communication system, in accordance with an embodiment. System architecture 100B (also referred to as “system” herein) includes switch 110 and endpoint devices 140A-N. System 100B further includes communication interface links 142A-N connecting the above components. In various embodiments, system 100B can include more or fewer components in different configurations than those depicted in FIG. 1B. For example, system 100B can include additional switches operating upstream or downstream from switch 110. System 100B differs from system 100A in that there is no distinction between upstream and downstream devices; all devices can perform host/device, controller/controlled, sender/receiver, or other types of roles. An example communication system that can correspond to system 100B is an Ethernet system. In various embodiments, the device roles of systems 100A-B can be combined with aspects of one or more of systems 100C-D.

FIG. 1C is a block diagram of an example system architecture 100C for a communication system, in accordance with an embodiment. System architecture 100C (also referred to as “system” herein) includes bus 150 and endpoint devices 140A-N. System 100C further includes communication interface links 142A-N connecting the above components. In various embodiments, system 100C can include more or fewer components in different configurations than those depicted in FIG. 1C. For example, system 100C can include additional buses 150. System 100C differs from systems 100A-B in that there is no switch connected multiple devices; rather, all devices share the same physical or virtual media bus 150. An example communication system that can correspond to system 100C is an I2C system. In various embodiments, the bus configuration of system 100C can be combined with aspects of one or more of systems 100A, 100B, or 100D.

FIG. 1D is a block diagram of an example system architecture 100D for a communication system, in accordance with an embodiment. System architecture 100D (also referred to as “system” herein) includes switch 110, upstream devices 120A-N, and downstream devices 130A-N. System 100A further includes multi-lane communication interface links 124A-N and 134A-N connecting the above components. In various embodiments, system 100D can include more or fewer components in different configurations than those depicted in FIG. 1D. For example, system 100D can include additional switches operating upstream or downstream from switch 110. System 100D includes communication interface links that can each have two or more lanes. An example communication system that can correspond to system 100D is a PCIe system. In various embodiments, the multi-lane communication interface links of system 100D can be combined with aspects of one or more of systems 100A-C.

Multi-lane communication interface links 124A-N can each have two or more lanes for sending and/or receiving traffic, and the number of active lanes (also referred to as “link width”) can be configurable in various embodiments. For example, multi-lane communication interface link 124A can be configured with one active lane, while multi-lane communication interface link 124B can be configured with four active lanes. In another example, multi-lane communication interface link 124A can transition from one active lane to four active lanes at a point in time, possibly with downtime to facilitate the transition. The bandwidth characteristic described above can refer to the overall bandwidth of the link, while a lane bandwidth characteristic can refer to the bandwidth of a single lane. In a multi-lane communication interface link, the link bandwidth can be the sum of the individual lane bandwidths. As described above, some embodiments of communication systems can support tunable link bandwidths, which in systems such as system 100D can include changing the link width (e.g., one to four) or changing the bandwidth of individual lanes (e.g., low bandwidth to high bandwidth).

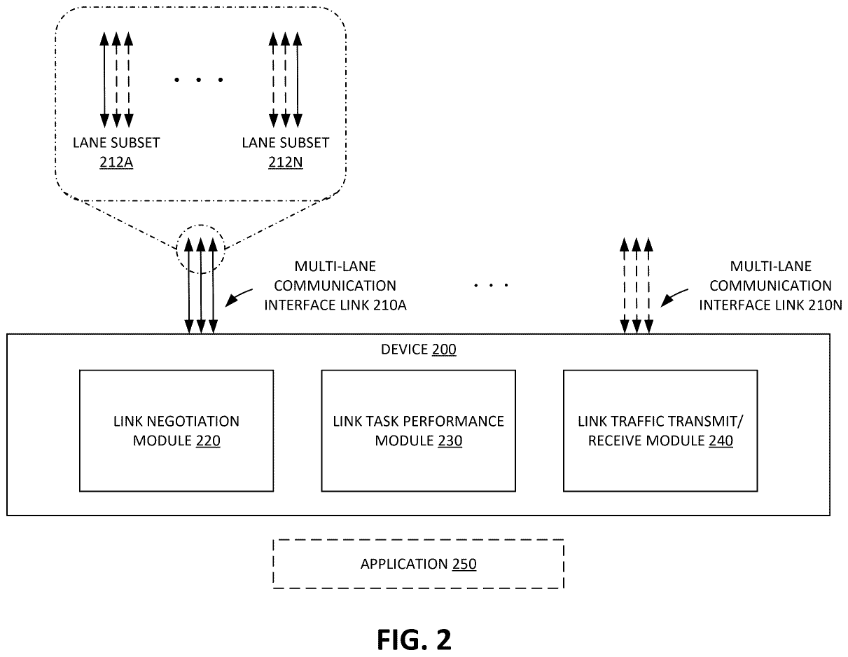

FIG. 2 is a block diagram of an example device 200 in a communication system, in accordance with an embodiment. In an embodiment, device 200 can be one of switch 110 or devices 120A-N, 130A-N, or 140A-N of FIGS. 1A-D. Device 200 is connected to one or more additional devices via one or more communication interface links 210A-N. Communication interface links 210A-N can be multi-lane links in various embodiments. Device 200 includes link negotiation module 220, link task performance module 230, and link traffic transmit/receive module 240. In various embodiments, device 200 can include more or fewer components than those depicted in FIG. 2. For example, device 200 can include modules for generating data to be transmitted on links 210A-N or modules for processing data received on links 210A-N. Device 200 can be a PCIe device, an Ethernet device, a USB device, or other type of device in various embodiments.

Link negotiation module 220 can communicate with a connected device to configure the connecting link and can implement various protocols to do so. Link negotiation module 220 can be used to bring up or bring down a link (e.g., for link initialization/de-initialization or for link maintenance). Link negotiation module 220 can also be used to update link parameters. For example, link negotiation module 220 can negotiate an updated bandwidth state. In a multi-lane communication interface link, an updated bandwidth state can be a change in link width or a change in bandwidth of individual lanes.

In an embodiment, link negotiation module 220 can be used to configure a subset of lanes of the connecting link, such as lane subsets 212A-N. For example, link negotiation module 220 can be used to bring up a subset of lanes, bring down a second subset of lanes, and/or update a bandwidth state of a third subset of lanes. Lane subsets can be in one or more of various states associated with link configuration, such as inactive (e.g., down, off), active used (e.g., up, transmitting/receiving traffic), and/or active unused (e.g. up, in maintenance mode). Link negotiation module 220 can implement various additional or modified protocols to support configuring link subsets. For example, link negotiation module 220 can specify which subset of lanes to use when narrowing (e.g., reducing active used lanes) or widening (e.g., increasing active used lanes). Link negotiation module 220 can further support different lane subsets operating in different configurations (e.g., operating at different bandwidths or in different states), and can further specify that two or more subsets of lane configurations/states should be swapped. In an embodiment, link negotiation module 220 can support a subset of the link configurations described herein. In an embodiment, link negotiation module 220 can indicate to a connected device(s) which configurations link negotiation module 220 supports or can indicate that link negotiation module 220 does or does not support a configuration requested by a connected device(s) (e.g., via additional data accompanying an acknowledgement or rejection response).

Link task performance module 230 can perform one or more tasks on a link or a subset of lanes of the link. For example, link task performance module 230 can perform margining or equalization (e.g., electrical tuning) of a link before bringing the link up, or re-equalization at a later point in time (e.g., due to excessive link errors, due to temperature or other environmental parameters affecting lane characteristics, etc.). Link traffic transmit/receive module 240 can use a link or a subset of lanes of the link to transmit or receive data to/from a connected device. In an embodiment, link task performance module 230 and link traffic transmit/receive module 240 do not simultaneously operate on/with the same subset of lanes of a link, but can operate simultaneously using different subsets of lanes of the link.

In an embodiment, various components of device 200 can be configurable. For example, the division of a link into one or more subsets of lanes, and tasks performed thereon, can be configured for different use cases. Components of device 200 can be configured in hardware or software. For example, device 200 can be configured by a software driver or application, such as application 250. Examples of applications that can configure device 200 include high-performance computing (HPC) applications, artificial intelligence (AI) applications, gaming applications, and similar. In an embodiment, device 200 can be configured using an application programming interface (API), such as an API provided by a device driver.

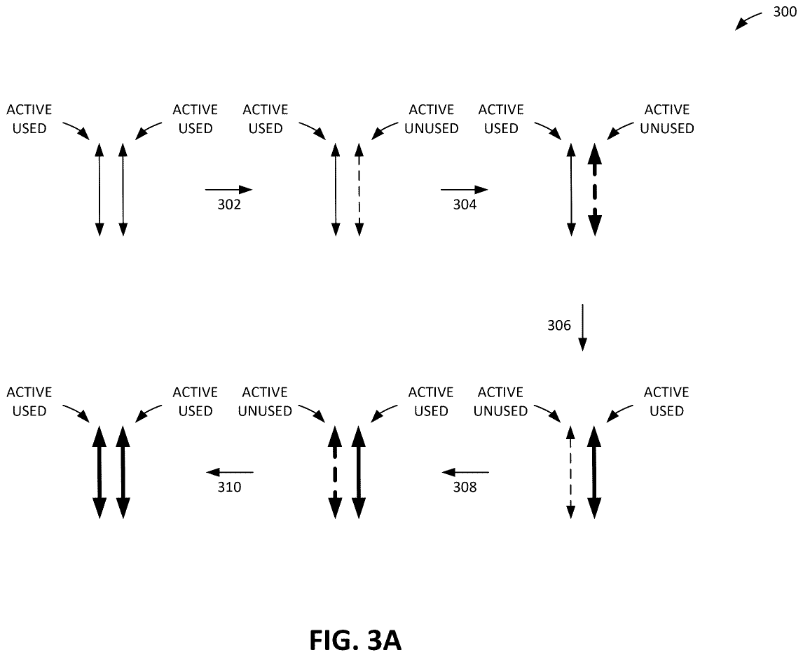

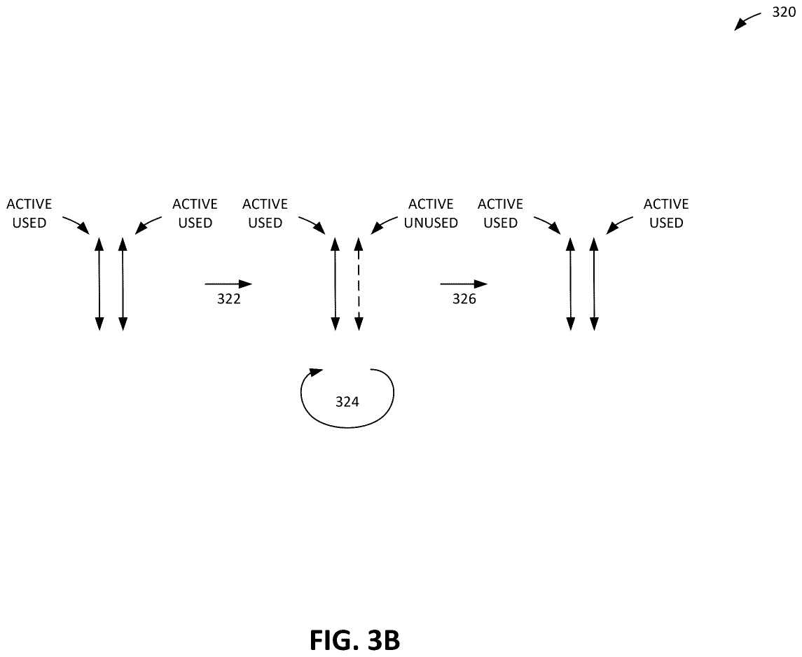

FIG. 3A depicts a sequence 300 of link states in a link bandwidth change operation, in accordance with an embodiment. Each link state in sequence 300 depicts a left subset and a right subset, each of which can include one or more lanes of the link. The initial link state is depicted as an active used state, where both left and right subsets are used for sending and/or receiving link traffic (e.g., by link traffic transmit/receive module 240). In various embodiments, a different initial link state can be used, such as an inactive state.

At operation 302, the right subset is configured to an active unused state (as depicted by the dashed line), while the left subset remains in the active used state. This configuration can be performed, for example, by link negotiation module 220 of FIG. 2. At operation 304, the right subset, in the active unused state, is configured to a different bandwidth state (e.g., higher or lower bandwidth, as depicted by the change in line width). This configuration can be performed, for example, by link negotiation module 220. Meanwhile, the left subset continues to send and receive traffic.

At operation 306, the states of the left and right subsets are swapped, such that the left subset is configured to an active unused state, while the right subset is configured in the active used state. Thus, link traffic continues to flow unimpeded. This configuration swap can be performed, for example, by link negotiation module 220.

At operation 308, the left subset, in the active unused state, is configured to a different bandwidth state, which can be the same (new) bandwidth state as configured for the right subset, or a different bandwidth state. This configuration can be performed, for example, by link negotiation module 220. At operation 310, the right subset is configured in the active used state, and link traffic is restored to the full link at the new bandwidth(s).

In an embodiment, sequence 300 can be expanded for a link divided into more than two subsets. For example, a link with three subsets can configure each subset to a new bandwidth in turn while one or both of the remaining subsets carry the link traffic. In various embodiments, different subsets can have the same or different numbers of lanes. In an embodiment, sequence 300 can be abbreviated to configure one subset to a new bandwidth while leaving the other subset in the original bandwidth configuration (e.g., analogous to sequence 320 of FIG. 3B).

FIG. 3B depicts a sequence 320 of link states in a link maintenance operation, in accordance with an embodiment. Each link state in sequence 320 depicts a left subset and a right subset, each of which can include one or more lanes of the link. The initial link state is depicted as an active used state, where both left and right subsets are used for sending and/or receiving link traffic (e.g., by link traffic transmit/receive module 240). In various embodiments, a different initial link state can be used, such as an inactive state.

At operation 322, the right subset is configured to an active unused state, while the left subset remains in the active used state. This configuration can be performed, for example, by link negotiation module 220. At operation 324, a link maintenance task is performed on the right subset while the left subset continues to send and receive traffic. Thus, link traffic continues to flow unimpeded. The link maintenance task can be performed by link task performance module 230 and can include lane margining, lane equalization, or other type of task. At operation 326, the right subset is configured in the active used state, and link traffic is restored to the full link.

In an embodiment, sequence 300 can be expanded to perform the same or similar link maintenance task on the left subset (e.g., analogous to sequence 300 of FIG. 3B). In an embodiment, sequence 320 can be further expanded for a link divided into more than two subsets. For example, a link with three subsets can perform maintenance tasks on each subset in turn while one or both of the remaining subsets carry the link traffic.

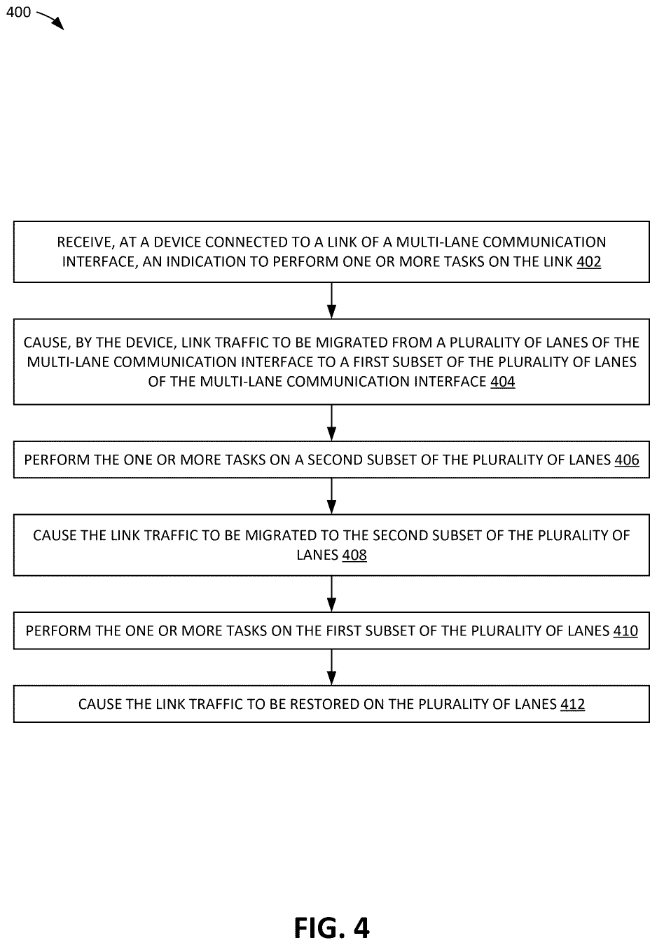

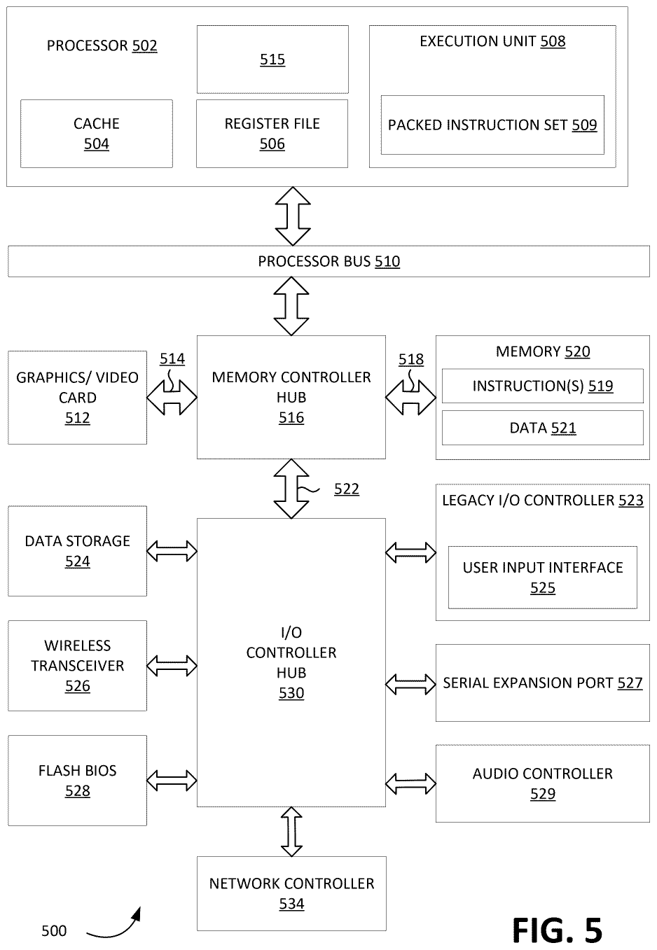

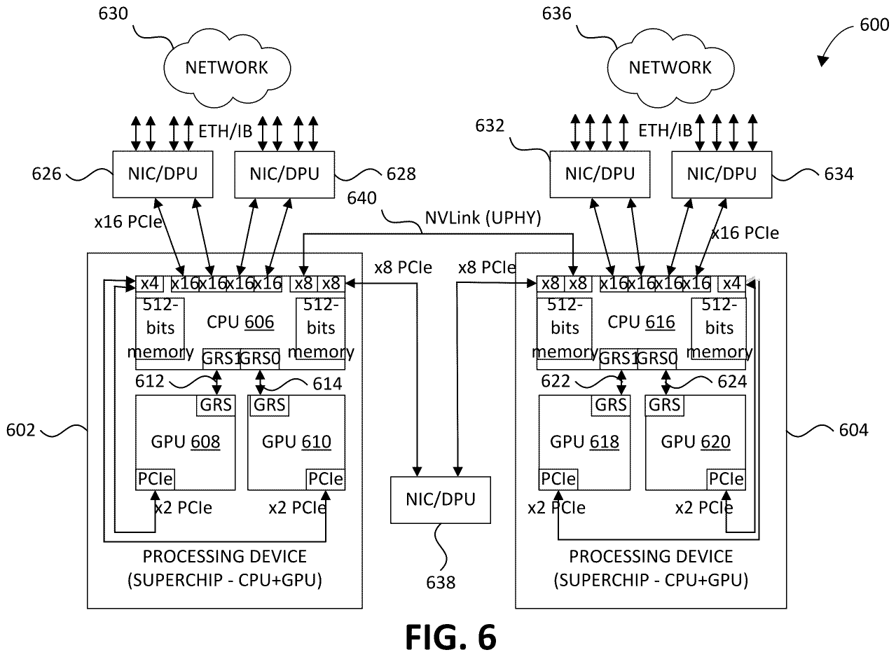

FIG. 4 is a flow diagram of an example method 400 for lane staggering in multi-lane communication interface links, in accordance with at least one embodiment. Method 400 can be performed by processing logic that can comprise hardware (e.g., circuitry, dedicated logic, etc.), computer-readable instructions such as software or firmware (e.g., run on a general-purpose computing system or a dedicated machine), or a combination thereof. For instance, an example system can include a memory and a processing device coupled to the memory device to perform operations comprising the blocks of method 400. Method 400 can also be associated with a set of instructions stored on a non-transitory computer-readable medium (e.g., magnetic or optical disk, etc.). The instructions, when executed by a processing device, can cause the processing device to perform operations comprising the blocks of method 400. In at least one embodiment, method 400 is performed by one or more of switch 110 or devices 120A-120N, 130A-N, or 140A-N of FIGS. 1A-D, or components thereof. In at least one embodiment, method 400 is performed by computing system 500 of FIG. 5. In some embodiments, blocks depicted in FIG. 4 could be performed simultaneously or in a different order than depicted. Various embodiments can include additional blocks not depicted in FIG. 4 or a subset of blocks depicted in FIG. 4.

At block 402, processing logic of a device connected to a link of a multi-lane communication interface receives an indication to perform one or more tasks on the link. The device can be switch 110, devices 120A-120N, 130A-N, or 140A-N, or device 200. The link of the communication interface can be one of communication interface links 122A-N, 124A-N, 132A-N, 142A-N, or 210A-N. The communication interface can be a PCIe interface, a CXL interface, an InfiniBand interface, an Ethernet interface, a USB interface, or similar. In an embodiment, the one or more tasks comprise changing a bandwidth of the link, equalizing the link in response to one or more communication errors, equalizing the link in response to one or more environmental parameter changes, or other types of tasks. In an embodiment, the link of the multi-lane communication interface is a Peripheral Component Interconnect Express (PCIe) link, and the one or more tasks comprise upgrading the PCIe link from a first PCIe generation speed (e.g., Gen 1 speed) to a second PCIe generation speed (e.g., Gen 6 speed). In an embodiment, the indication to perform the one or more tasks is associated with an application (e.g., application 250), such as one or more of a high-performance computing (HPC) application, an artificial intelligence (AI) application, or a gaming application.

At block 404, the processing logic causes link traffic to be migrated from a plurality of lanes of the multi-lane communication interface to a first subset of the plurality of lanes of the multi-lane communication interface. The first subset of the plurality of lanes can be the left subset of FIGS. 3A-B (e.g., the subset remaining in the active used state), for example. In an embodiment, causing the link traffic to be migrated from the plurality of lanes to the first subset of the plurality of lanes comprises sending, to a second device connected to the link, a request to reduce a link width of the link from the plurality of lanes to the first subset of the plurality of lanes. For example, the request can be sent by link negotiation module 220 to reconfigure a second subset of lanes (e.g., the right subset of FIGS. 3A-B) to an active unused state and/or to migrate traffic to the first subset. In an embodiment, block 404 corresponds to operations 302 and/or 322 of FIGS. 3A-B.

At block 406, the processing logic performs the one or more tasks on a second subset of the plurality of lanes. In various embodiments, the one or more tasks can be performed by link negotiation module 220, link task performance module 230, or other component of the device. In an embodiment, the one or more tasks are performed on the second subset while the link traffic is being handled by the first subset. Thus, the link traffic continues to flow without interruption. In an embodiment, block 406 corresponds to operations 304 and/or 324.

At block 408, the processing logic causes the link traffic to be migrated to the second subset of the plurality of lanes. In an embodiment, block 408 corresponds to operation 306. At block 410, the processing logic performs the one or more tasks on the first subset of the plurality of lanes. In various embodiments, the tasks performed on the first subset can be the same as or different from the tasks performed on the second subset. In an embodiment, block 410 corresponds to operation 308. At block 412, the processing logic causes the link traffic to be restored on the plurality of lanes. In an embodiment, block 412 corresponds to operation 310.

In various embodiments, the link can be divided into more than two subsets, and one or more of blocks 402-412 can be repeated or extended to the additional subset(s). In an embodiment, a third subset of the plurality of lanes can be dormant or inactive while the first and second subsets are in the active used or active unused states. In an embodiment, the first, second, and third subsets of the plurality of lanes are mutually exclusive (e.g., no lane of the link belongs to more than one subset).

FIG. 5 is a block diagram illustrating an exemplary computer system, which may be a system with interconnected devices and components, a system-on-a-chip (SOC) or some combination thereof 500 formed with a processor that may include execution units to execute an instruction, according to at least one embodiment. In at least one embodiment, computer system 500 may include, without limitation, a component, such as a processor 502 to employ execution units including logic to perform algorithms for process data, in accordance with present disclosure, such as in embodiment described herein. In at least one embodiment, computer system 500 may include processors, such as PENTIUM® Processor family, Xeon™, Itanium®, XScale™ and/or StrongARM™, Intel® Core™, or Intel® Nervana™ microprocessors available from Intel Corporation of Santa Clara, California, although other systems (including PCs having other microprocessors, engineering workstations, set-top boxes and like) may also be used. In at least one embodiment, computer system 500 may execute a version of WINDOWS' operating system available from Microsoft Corporation of Redmond, Wash., although other operating systems (UNIX and Linux for example), embedded software, and/or graphical user interfaces, may also be used.

Embodiments may be used in other devices such as handheld devices and embedded applications. Some examples of handheld devices include cellular phones, Internet Protocol devices, digital cameras, personal digital assistants (“PDAs”), and handheld PCs. In at least one embodiment, embedded applications may include a microcontroller, a digital signal processor (“DSP”), system on a chip, network computers (“NetPCs”), set-top boxes, network hubs, wide area network (“WAN”) switches, edge devices, Internet-of-Things (“IoT”) devices, or any other system that may perform one or more instructions in accordance with at least one embodiment.

In at least one embodiment, computer system 500 may include, without limitation, processor 502 that may include, without limitation, one or more execution units 508 to perform machine learning model training and/or inferencing according to techniques described herein. In at least one embodiment, computer system 500 is a single processor desktop or server system, but in another embodiment computer system 500 may be a multiprocessor system. In at least one embodiment, processor 502 may include, without limitation, a complex instruction set computer (“CISC”) microprocessor, a reduced instruction set computing (“RISC”) microprocessor, a very long instruction word (“VLIW”) microprocessor, a processor implementing a combination of instruction sets, or any other processor device, such as a digital signal processor, for example. In at least one embodiment, processor 502 may be coupled to a processor bus 510 that may transmit data signals between processor 502 and other components in computer system 500.

In at least one embodiment, processor 502 may include, without limitation, a Level 1 (“L1”) internal cache memory (“cache”) 504. In at least one embodiment, processor 502 may have a single internal cache or multiple levels of internal cache. In at least one embodiment, cache memory may reside external to processor 502. Other embodiments may also include a combination of both internal and external caches depending on particular implementation and needs. In at least one embodiment, register file 506 may store different types of data in various registers including, without limitation, integer registers, floating point registers, status registers, and instruction pointer register.

In at least one embodiment, execution unit 508, including, without limitation, logic to perform integer and floating-point operations, also resides in processor 502. In at least one embodiment, processor 502 may also include a microcode (“ucode”) read-only memory (“ROM”) that stores microcode for certain macro instructions. In at least one embodiment, execution unit 508 may include logic to handle a packed instruction set 509. In at least one embodiment, by including packed instruction set 509 in an instruction set of a general-purpose processor 502, along with associated circuitry to execute instructions, operations used by many multimedia applications may be performed using packed data in a general-purpose processor 502. In one or more embodiments, many multimedia applications may be accelerated and executed more efficiently by using full width of a processor's data bus for performing operations on packed data, which may eliminate need to transfer smaller units of data across processor's data bus to perform one or more operations one data element at a time.

In at least one embodiment, execution unit 508 may also be used in microcontrollers, embedded processors, graphics devices, DSPs, and other types of logic circuits. In at least one embodiment, computer system 500 may include, without limitation, a memory 520. In at least one embodiment, memory 520 may be implemented as a Dynamic Random Access Memory (“DRAM”) device, a Static Random Access Memory (“SRAM”) device, flash memory device, or other memory device. In at least one embodiment, memory 520 may store instruction(s) 519 and/or data 521 represented by data signals that may be executed by processor 502.

In at least one embodiment, system logic chip may be coupled to processor bus 510 and memory 520. In at least one embodiment, system logic chip may include, without limitation, a memory controller hub (“MCH”) 516, and processor 502 may communicate with MCH 516 via processor bus 510. In at least one embodiment, MCH 516 may provide a high bandwidth memory path 518 to memory 520 for instruction and data storage and for storage of graphics commands, data and textures. In at least one embodiment, MCH 516 may direct data signals between processor 502, memory 520, and other components in computer system 500 and to bridge data signals between processor bus 510, memory 520, and a system I/O 522. In at least one embodiment, system logic chip may provide a graphics port for coupling to a graphics controller. In at least one embodiment, MCH 516 may be coupled to memory 520 through a high bandwidth memory path 518 and graphics/video card 512 may be coupled to MCH 516 through an Accelerated Graphics Port (“AGP”) interconnect 514.

In at least one embodiment, computer system 500 may use system I/O 522 that is a proprietary hub interface bus to couple MCH 516 to I/O controller hub (“ICH”) 530. In at least one embodiment, ICH 530 may provide direct connections to some I/O devices via a local I/O bus. In at least one embodiment, local I/O bus may include, without limitation, a high-speed I/O bus for connecting peripherals to memory 520, chipset, and processor 502. Examples may include, without limitation, an audio controller 529, a firmware hub (“flash BIOS”) 528, a wireless transceiver 526, a data storage 524, a legacy I/O controller 523 containing user input and keyboard interfaces 525, a serial expansion port 527, such as Universal Serial Bus (“USB”), and a network controller 534, which may include in some embodiments, a data processing unit. Data storage 524 may comprise a hard disk drive, a floppy disk drive, a CD-ROM device, a flash memory device, or other mass storage device.

In at least one embodiment, FIG. 5 illustrates a system, which includes interconnected hardware devices or “chips,” whereas in other embodiments, FIG. 5 may illustrate an exemplary System on a Chip (“SoC”). In at least one embodiment, devices may be interconnected with proprietary interconnects, standardized interconnects (e.g., PCIe) or some combination thereof. In at least one embodiment, one or more components of computer system 500 are interconnected using compute express link (CXL) interconnects. In at least one embodiment, system 500 can correspond to systems 100A-D or components thereof, such as devices 120A-N, 130A-N, 140A-N, 200, and connecting links 122A-N, 124A-N, 132A-N, 142A-N, and 210A-N.

FIG. 6 is a block diagram of a computing system 600 having two processing devices coupled to each other and multiple networks according to at least one embodiment. The computing system 600 is designed with multiple integrated circuits (referred to as processing devices), where each integrated circuit includes a CPU and two GPUs, forming a powerful and flexible architecture. These processing devices are interconnected via an NVLink (or other high-speed interconnect), enabling high-speed communication between the processing devices, and are also connected through a Network Interface Card (NIC) or Data Processing Unit (DPU) to ensure efficient data transfer across the computing system 600. The coupling of processing devices through NVLink allows for seamless data exchange and parallel processing, enhancing overall computational performance. Additionally, these processing devices are connected to multiple networks through one or more network interface cards (NICs) or DPUs, enabling the system to handle complex, multi-network tasks with high bandwidth and low latency. This configuration makes the computing system 600 highly suitable for demanding applications that require significant processing power, such as artificial intelligence (AI), machine learning (ML), and data-intensive computing, while ensuring robust connectivity and scalability across various networked environments. The integrated circuits of the computing system 600 can include one or more CPUs and one or more GPUs. An example architecture of a multi-GPU architecture is illustrated in FIG. 6.

As illustrated in FIG. 6, the computing system 600 includes a processing device 602 with a multi-GPU architecture. In particular, the processing device 602 includes a CPU 606, a GPU 608, and a GPU 610. The CPU 606 can be coupled to the GPU 608 via an die-to-die (D2D) or chip-to-chip (C2C) interconnect 612, such as a Ground-Referenced Signaling interconnect (GRS interconnect). The CPU 606 can be coupled to the GPU 610 via a D2D or C2C interconnect 614. The CPU 606 can also couple to the GPU 608 and GPU 610 via PCIe interconnects. The CPU 606 can be coupled to one or more network interface cards (NICs) or data processing units (DPUs), which are coupled to one or more networks. For example, as illustrated in FIG. 6, the CPU 606 is coupled to a first NIC/DPU 626, which is coupled to a network 630. The CPU 606 is also coupled to a second NIC/DPU 628, which is coupled to the network 630. The NIC/DPU 626 and NIC/DPU 628 can be coupled to the network 630 over Ethernet (ETH) or InfiniBand (IB) connections.

The computing system 600 also includes a processing device 604 with a multi-GPU architecture. In particular, the processing device 604 includes a CPU 616, a GPU 618, and a GPU 620. The CPU 616 can be coupled to the GPU 618 via an D2D or C2C interconnect 622. The CPU 616 can be coupled to the GPU 620 via a D2D or C2C interconnect 624. The CPU 616 can also couple to the GPU 618 and GPU 620 via PCIe interconnects. The CPU 616 can be coupled to one or more NICs or DPUs, which are coupled to one or more networks. For example, as illustrated in FIG. 6, the CPU 616 is coupled to a first NIC/DPU 632, which is coupled to a network 636. The CPU 616 is also coupled to a second NIC/DPU 634, which is coupled to the network 636. The NIC/DPU 632 and NIC/DPU 634 can be coupled to the network 636 over Ethernet (ETH) or InfiniBand (IB) connections.

In at least one embodiment, the processing device 602 and the processing device 604 can communication with each other via a NIC/DPU 638, such as over PCIe interconnects. The processing device 602 and processing device 604 can also communicate with each other over a high-bandwidth communication interconnects 640, such as an NVLink interconnect or other high-speed interconnects.

In at least one embodiment, the computing system 600 is used for high-speed network communication and includes a processing unit (e.g., CPU 606, GPU 608, GPU 610, CPU 616, GPU 618, GPU 620, NIC/DPU 626, NIC/DPU 628, NIC/DPU 632, NIC/DPU 634, or NIC/DPU 638), a memory coupled to the processing unit(s), and a network interface coupled to the processing unit(s) and memory via a link of a communication interface. In various embodiments, one or more of the linked devices can include components described with reference to FIG. 2 for staggering lanes of a multi-lane communication interface and performing one or more tasks on the lanes.

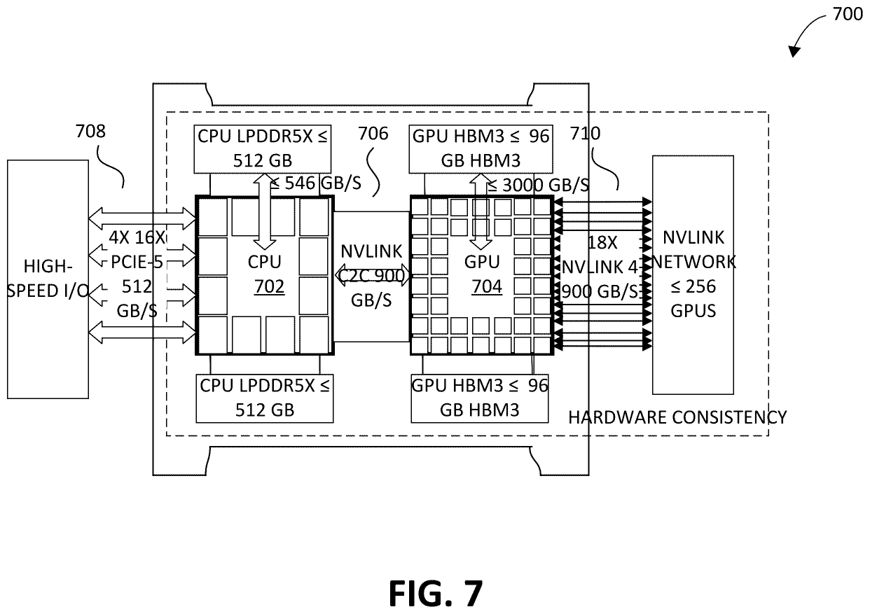

FIG. 7 is a block diagram of a computing system 700 having a CPU 702 and a GPU 704 in a single integrated circuit according to at least one embodiment. The computing system 700 can be a highly integrated design where a CPU 702 and GPU 704 are connected on a single integrated circuit, utilizing an NVLink C2C (Chip-to-Chip) interconnect 706 to enable fast, low-latency communication between the two processing units. This close integration allows for efficient data transfer and parallel processing between the CPU 702 and GPU 704, optimizing performance for complex computational tasks. The GPU elements within the computing system 700 can be interconnected using an NVLink network, allowing for scalability up to 256 GPU elements, creating a powerful, unified processing environment ideal for large-scale AI, ML, and high-performance computing applications. The NVLink network can be a GPU fabric of high-bandwidth communication interconnects 710. Additionally, the computing system 700 can be designed to interface with a high-speed I/O through PCIe interconnects 708, ensuring rapid data transfer to and from external devices, further enhancing the system's capabilities in handling data-intensive tasks and providing robust connectivity to peripheral components. It should be noted that the C2C interconnects 706 can be considered D2D interconnects since the CPU 702 and the GPU 704 are located on the same integrated circuit. The integrated circuit can include CPU memory (also referred to as main memory) and GPU memory, which are accessible by the CPU 702 and the GPU 704, respectively, over high-speed interconnects. The computing system 700 can bring together performance of the GPU 704 with the versatility of the CPU 702. The CPU 702 can be connected with a high-bandwidth and memory coherent C2C interconnects 706 in a single integrated circuit. The computing system 700 can support a link switch system.

In at least one embodiment, the computing system 700 is used for high-speed network communication and includes a processing unit (e.g., CPU 702, GPU 704, NVLink network), a memory coupled to the processing unit(s), and a network interface coupled to the processing unit(s) and memory via a link of a communication interface. In various embodiments, one or more of the linked devices can include components described with reference to FIG. 2 for staggering lanes of a multi-lane communication interface and performing one or more tasks on the lanes.

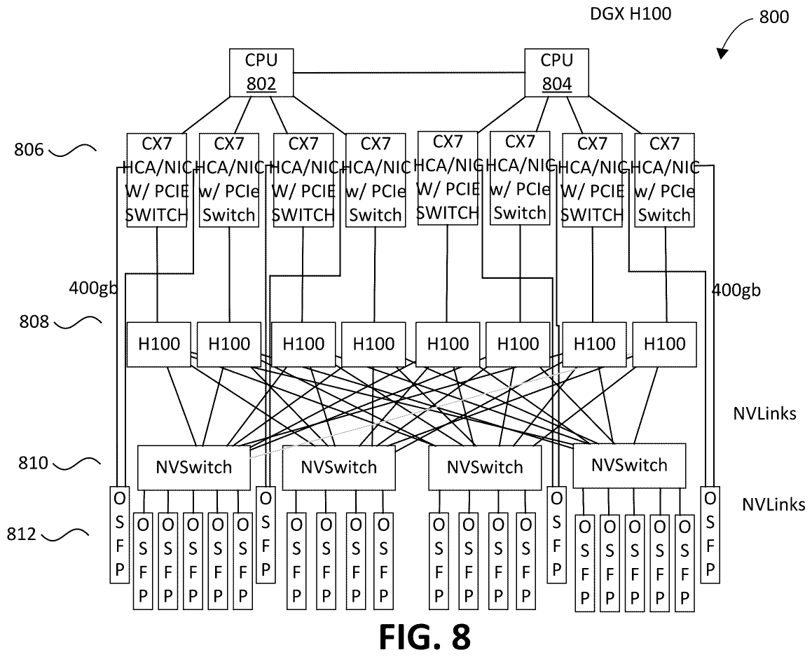

FIG. 8 is a block diagram of a computing system 800 having tensor core GPUs 808 according to at least one embodiment. The computing system 800 can be a DGX H100 system, which is a high-performance computing platform designed to meet the demands of AI, ML, and deep learning (DL) workloads. The computing system 800 can include multiple tensor core GPUs 808 (e.g., NVIDIA H100 Tensor Core GPUs). The tensor core GPUs 808 can each be one of the integrated circuits described above with respect to FIG. 7. The tensor core GPUs 808 can be optimized for AI/ML/DL applications, offering exceptional performance for deep learning training, inference, and high-performance computing tasks. The tensor core GPUs 808 within the computing system 800 are interconnected using high-speed communication interfaces like NVLinks, enabling rapid data transfer between them, which is crucial for handling large-scale AI models and datasets with low latency. This computing system 800 is designed for scalability, allowing for the integration of additional GPUs as required, making it versatile enough for research, development, and deployment in data centers for production AI workloads. Each GPU is equipped with Tensor Cores, specialized processing units that accelerate matrix operations, a fundamental component of AI and deep learning algorithms. These Tensor Cores enable the system to perform mixed-precision calculations efficiently, balancing speed and accuracy. Given the power consumption and heat generation of multiple tensor core GPUs 808, the computing system 800 can include advanced cooling solutions and power management features to ensure safe operation while maintaining peak performance. It is supported by a comprehensive software ecosystem, including NVIDIA's CUDA programming model, AI frameworks like TensorFlow and PyTorch, and other HPC and AI software tools, which enable developers and researchers to harness the full power of the tensor core GPUs 808 for their specific applications. The computing system 800 is ideally suited for large-scale AI model training, real-time inference, scientific simulations, data analytics, and other compute-intensive tasks that require massive parallel processing power.

The tensor core GPUs 808 can be coupled to multiple CPUs, such as CPU 802 and CPU 804, using switches 806 (e.g., CX7 HCA/NIC with PCIe switch). The tensor core GPUs 808 can be coupled to each other via switches 810 (e.g., NVSwitches). The switches 806 and switches 810 can be coupled to high-speed transceiver modules 812. The high-speed transceiver modules 812 can be Octal Small Form-factor Pluggable (OSFP) modules. OSFP modules refer to high-speed transceiver modules designed for rapid data communication, particularly in environments requiring significant bandwidth, such as data centers and high-performance computing systems. These modules support extremely high data rates, typically up to 400 Gbps per module, with future capabilities extending to 800 Gbps or more. OSFP modules interface with the system via the PCIe interface, enabling fast and efficient data transfer between the integrated CPU-GPU components and external networks or other connected systems. Their hot-pluggable nature allows for easy insertion or removal without the need to power down the system, offering flexibility and ease of maintenance, which is crucial in critical-uptime environments. Additionally, OSFP modules are designed for high density, maximizing the number of high-speed connections within limited space, such as in densely packed server racks. By adhering to the latest networking standards, OSFP modules ensure the computing system 800 remains capable of meeting increasing data demands and can be upgraded to support future advancements in network speeds, thus contributing to the system's overall performance and scalability.

In at least one embodiment, the computing system 800 can be considered a data-network configuration with full-bandwidth intra-server NVLinks. In this example, all eight tensor core GPUs 808 can simultaneously saturate eighteen NVLinks to other GPUs within the server. The bandwidth is limited by over-subscription from multiple other GPUs. In another embodiments, data-network configuration can be a half-bandwidth intra-server NVLinks. In this example, all eight tensor core GPUs 808 can half-subscribe eighteen NVLinks to GPUs in other servers. Four tensor core GPUs 808 can saturate eighteen NVLinks to GPUs in other servers. This is equivalent of full-bandwidth on AllReduce with Scalable Hierarchical Aggregation and Reduction Protocol (SHARP). The reduction in all-2-all (All2All) bandwidth is a balance with server complexity and costs. In at least one embodiment, all eight tensor core GPUs 808 can independently transfer data, using Remote Direct Memory Access (RDMA) protocol, over its own dedicated switch (e.g., 400 Gb/s HCA/NIC) in a multi-rail InfiniBand/Ethernet configuration. In this example, 800 GBps of aggregate full-duplex to non-NVLink network devices.

In at least one embodiment, the computing system 800 is used for high-speed network communication and includes a processing unit (e.g., CPU 802, CPU 802, switches 806, tensor core GPUs 808, switches 810, high-speed transceiver modules 812), and a network interface coupled to the processing unit via a link of a communication interface. In various embodiments, one or more of the linked devices can include components described with reference to FIG. 2 for staggering lanes of a multi-lane communication interface and performing one or more tasks on the lanes.

Other variations are within spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. Term “connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. Use of term “set” (e.g., “a set of items”) or “subset,” unless otherwise noted or contradicted by context, is to be construed as a nonempty collection comprising one or more members. Further, unless otherwise noted or contradicted by context, term “subset” of a corresponding set does not necessarily denote a proper subset of corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B, and at least one of C each to be present. In addition, unless otherwise noted or contradicted by context, term “plurality” indicates a state of being plural (e.g., “a plurality of items” indicates multiple items). A plurality is at least two items but may be more when so indicated either explicitly or by context. Further, unless stated otherwise or otherwise clear from context, phrase “based on” means “based at least in part on” and not “based solely on.”

Operations of processes described herein may be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. A set of non-transitory computer-readable storage media, in at least one embodiment, comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors-for example, a non-transitory computer-readable storage medium store instructions and a main central processing unit (“CPU”) executes some of instructions while a graphics processing unit (“GPU”) executes other instructions. In at least one embodiment, different components of a computer system have separate processors and different processors execute different subsets of instructions.

Accordingly, in at least one embodiment, computer systems are configured to implement one or more services that singly or collectively perform operations of processes described herein and such computer systems are configured with applicable hardware and/or software that enable performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

All references, including publications, patent applications, and patents, cited herein are hereby incorporated by reference to same extent as if each reference were individually and specifically indicated to be incorporated by reference and were set forth in its entirety herein.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, term “processor” may refer to any device or portion of a device that processes electronic data from registers and/or memory and transform that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. Terms “system” and “method” are used herein interchangeably insofar as system may embody one or more methods and methods may be considered a system.

In present document, references may be made to obtaining, acquiring, receiving, or inputting analog or digital data into a subsystem, computer system, or computer-implemented machine. Obtaining, acquiring, receiving, or inputting analog and digital data may be accomplished in a variety of ways such as by receiving data as a parameter of a function call or a call to an application programming interface. In some implementations, process of obtaining, acquiring, receiving, or inputting analog or digital data may be accomplished by transferring data via a serial or parallel interface. In another implementation, process of obtaining, acquiring, receiving, or inputting analog or digital data may be accomplished by transferring data via a computer network from providing entity to acquiring entity. References may also be made to providing, outputting, transmitting, sending, or presenting analog or digital data. In various examples, process of providing, outputting, transmitting, sending, or presenting analog or digital data may be accomplished by transferring data as an input or output parameter of a function call, a parameter of an application programming interface or interprocess communication mechanism.

Although discussion above sets forth example implementations of described techniques, other architectures may be used to implement described functionality, and are intended to be within scope of this disclosure. Furthermore, although specific distributions of responsibilities are defined above for purposes of discussion, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A method comprising:
causing, by a device connected to a link of a multi-lane communication interface, link traffic to be migrated from a plurality of lanes of the multi-lane communication interface to a first subset of the plurality of lanes of the multi-lane communication interface;
performing one or more tasks on a second subset of the plurality of lanes; and
causing the link traffic to be restored on the plurality of lanes.

2. The method of claim 1, wherein the one or more tasks are performed on the second subset while the link traffic is being handled by the first subset.

3. The method of claim 1, further comprising:
causing the link traffic to be migrated to the second subset of the plurality of lanes; and
performing the one or more tasks on the first subset of the plurality of lanes.

4. The method of claim 1, wherein the one or more tasks comprise:
changing a bandwidth of the link; or
equalizing the link in response to one or more communication errors.

5. The method of claim 1, wherein causing the link traffic to be migrated from the plurality of lanes to the first subset of the plurality of lanes comprises:
sending, to a second device connected to the link, a request to reduce a link width of the link from the plurality of lanes to the first subset of the plurality of lanes.

6. The method of claim 1, wherein the link of the multi-lane communication interface is a Peripheral Component Interconnect Express (PCIe) link, and wherein the one or more tasks comprise upgrading the PCIe link from a first PCIe generation speed to a second PCIe generation speed.

7. The method of claim 1, wherein a third subset of the plurality of lanes is dormant, and wherein the first, second, and third subsets of the plurality of lanes are mutually exclusive.

8. The method of claim 1, further comprising:
receiving, at the device, an indication to perform the one or more tasks.

9. The method of claim 8, wherein the indication to perform the one or more tasks is associated with an application, and wherein the application is one of: a high-performance computing (HPC) application, an artificial intelligence (AI) application, or a gaming application.

10. A system for a device connected to a link of a multi-lane communication interface, the system comprising:
a memory; and
one or more processing units, coupled to the memory, to perform operations comprising:
causing link traffic to be migrated from a plurality of lanes of the multi-lane communication interface to a first subset of the plurality of lanes of the multi-lane communication interface;
performing one or more tasks on a second subset of the plurality of lanes; and
causing the link traffic to be restored on the plurality of lanes.

11. The system of claim 10, wherein the one or more tasks are performed on the second subset while the link traffic is being handled by the first subset.

12. The system of claim 10, the operations further comprising:
causing the link traffic to be migrated to the second subset of the plurality of lanes; and
performing the one or more tasks on the first subset of the plurality of lanes.

13. The system of claim 10, wherein the one or more tasks comprise:
changing a bandwidth of the link; or
equalizing the link in response to one or more communication errors.

14. The system of claim 10, wherein causing the link traffic to be migrated from the plurality of lanes to the first subset of the plurality of lanes comprises:
sending, to a second device connected to the link, a request to reduce a link width of the link from the plurality of lanes to the first subset of the plurality of lanes.

15. The system of claim 10, wherein the link of the multi-lane communication interface is a Peripheral Component Interconnect Express (PCIe) link, and wherein the one or more tasks comprise upgrading the PCIe link from a first PCIe generation speed to a second PCIe generation speed.

16. The system of claim 10, wherein a third subset of the plurality of lanes is dormant, and wherein the first, second, and third subsets of the plurality of lanes are mutually exclusive.

17. The system of claim 10, the operations further comprising:
receiving an indication to perform the one or more tasks.

18. The system of claim 17, wherein the indication to perform the one or more tasks is associated with an application, and wherein the application is one of: a high-performance computing (HPC) application, an artificial intelligence (AI) application, or a gaming application.

19. A non-transitory computer-readable medium comprising instructions that, when executed by a processing unit of a device connected to a link of a multi-lane communication interface, cause the processing unit to perform operations comprising:
causing link traffic to be migrated from a plurality of lanes of the multi-lane communication interface to a first subset of the plurality of lanes of the multi-lane communication interface;
performing one or more tasks on a second subset of the plurality of lanes; and
causing the link traffic to be restored on the plurality of lanes.

20. The non-transitory computer-readable medium of claim 19, wherein the one or more tasks are performed on the second subset while the link traffic is being handled by the first subset.

21. The non-transitory computer-readable medium of claim 19, the operations further comprising:
causing the link traffic to be migrated to the second subset of the plurality of lanes; and
performing the one or more tasks on the first subset of the plurality of lanes.

22. The non-transitory computer-readable medium of claim 19, wherein the one or more tasks comprise:
changing a bandwidth of the link; or
equalizing the link in response to one or more communication errors.

23. A system for high-speed network communication in a data center, the system comprising:
one or more processing units;
a memory coupled to the one or more processing units; and
a network interface coupled to the one or more processing units and the memory via a link of a multi-lane communication interface, wherein the network interface is to perform operations comprising:
causing link traffic to be migrated from a plurality of lanes of the multi-lane communication interface to a first subset of the plurality of lanes of the multi-lane communication interface;
performing one or more tasks on a second subset of the plurality of lanes; and
causing the link traffic to be restored on the plurality of lanes.

24. The system of claim 23, wherein the one or more tasks are performed on the second subset while the link traffic is being handled by the first subset.

25. The system of claim 23, the operations further comprising:
causing the link traffic to be migrated to the second subset of the plurality of lanes; and
performing the one or more tasks on the first subset of the plurality of lanes.

26. The system of claim 23, wherein the one or more tasks comprise:
changing a bandwidth of the link; or
equalizing the link in response to one or more communication errors.
